(19) United States
(12) Patent Application Publication
(10) Pub. No.: US 2003/0065930 A1
(43) Pub. Date: Apr. 3, 2003

(54) Encryption/decryption apparatus and method

(76) Inventor: Shigeyuki Fukushima, Fuchu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/242,628

(22) Filed: Sep. 13, 2002

(30) Foreign Application Priority Data
Sep. 28, 2001 (JP) 2001-303407

(51) Int. Cl. H04L 9/32

(52) U.S. Cl. 713/189

(57) ABSTRACT

In each embodiment of the invention, the security unit device operating independently of a PC encrypts and decrypts data, adding a signature to data encrypted or decrypted, and verifies the signature. Hence, the key data and the encryption algorithm can be protected from the implementing of illegal software. This enables the PC to exchange data in security, with any other PC linked to it.

### CROSS-REFERENCE TO RELATED APPLICATIONS

This application is based upon and claims the benefit of priority from the prior Japanese Patent Application No. 2001-303407, filed Sep. 28, 2001, the entire contents of which are incorporated herein by reference.

### BACKGROUND OF THE INVENTION

1. Field of the Invention

The present invention relates to an encryption/decryption apparatus and method for use in personal computers (hereinafter referred to as “PCs”) connected to the Internet, which enable the PCs to exchange information in security.

2. Description of the Related Art

In recent years, information to be exchanged between PCs via the Internet is usually encrypted decrypted and a signature is usually added to each item of such information and verified, in order to protect the information.

The information to be exchanged is, for example, the user data that an user transmits from his or her PC to perform an electronic commerce', or content data that a supplier transmits when he or she distributes digital contents to personal PCs. The information is encrypted and decrypted and a signature is added to the information and verified, by using the key data and the encryption algorithm, both contained in the basic software described to implement, for example, electronic commerce and distribution of digital contents.

However, the user data can be easily stolen or illegally altered, merely by adding illegal software to the basic software. This is inevitably because the key data is contained in the basic software.

Similarly, the digital data can be easily changed or copied illegally, if the encryption algorithm is replaced by illegal software. This is because the encryption algorithm is nothing more than software.

Namely, the plain user data and plain digital data can be easily processed by using illegal software in the conventional information exchange implemented by the use of PCs.

### BRIEF SUMMARY OF THE INVENTION

An object of the present invention is to provide an encryption/decryption apparatus and method that can prevent key data and encryption algorithm from being processed by the use of illegal software, thereby to protect the key data and the encryption algorithm.

According to a first aspect of the present invention, there is provided an encryption/decryption apparatus to be connected to a computer by an input/output bus, to encrypt or decrypt the data input from the input/output bus and to output the data encrypted or decrypted. The encryption/decryption apparatus comprises: key memory means for storing a key specific to the apparatus; key storage means for storing a key-pair of public-key cryptographic scheme and a key of secret-key cryptographic scheme which have been encrypted by using the key stored in the key-memory means; program storage means for storing an encryption algorithm of public-key cryptographic scheme and an encryption algorithm of secret-key cryptographic scheme; an input/output bus I/F to input and output data to and from the input/output bus; arithmetic processing means for encrypting and decrypting the data input from the input/output bus I/F by using the keys stored in the key memory means storing and key storage means and the algorithms stored in the program storage means; an arithmetic operation area in which the encryption algorithm and encrypted/decrypted data are temporarily stored to be used by the arithmetic processing means; and output control means for controlling a destination which is to receive the data encrypted or decrypted by the arithmetic processing means, in accordance with the data input from the input/output bus I/F.

The apparatus encrypts and decrypts data, independently of the computer. The key data and the encryption program can therefore be protected from the implementing of illegal software. This enhances the security of data exchange between the computer and any other computer linked to the computer.

According to a second aspect of the invention, there is provided an encryption/decryption method for a computer capable performing network communication. The method comprises: connecting an encryption/decryption apparatus to the computer by an input/output bus; and encrypting data to be transmitted and decrypting data received in the encryption/decryption apparatus to enable the computer to perform the network communication.

The method achieves the same advantages as in the apparatus according to the first aspect of this invention.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a communication terminal that incorporates an encryption apparatus according to one embodiment of the present invention;

FIG. 2 is a block diagram depicting the security unit provided in the encryption apparatus;

FIG. 3 is a block diagram explaining the mutual authentication process performed in the encryption apparatus;

FIG. 4 is a block diagram showing the process performed in the encryption apparatus to register a key data;

FIG. 5 is a block diagram illustrating the process carried out in the encryption apparatus to encrypt information in a specific manner;

FIG. 6 is a block diagram explaining the process effected in the encryption apparatus to add a signature to the information;

FIG. 7 is a block diagram illustrating the process carried out in the encryption apparatus to encrypt information in a different manner;

FIG. 8 is a block diagram explaining the process carried out in the encryption apparatus to decrypt information in a specific way;

FIG. 9 is a block diagram showing the process carried out in the encryption apparatus to decrypt information in another way; and

FIG. 10 is a block diagram illustrating the process carried out in the encryption apparatus to edit information.

### DETAILED DESCRIPTION OF THE INVENTION

An embodiment of this invention will be described, with reference to the accompanying drawings. In the following description, “Ea (K, M)” denotes “data generated by encrypting data M with key K, using algorithm a,” “Da (K, C) means “data generated by decrypting data C with key K, using algorithm a.” The notation “Sa (K, M)” denotes “signature generated for data M with key K, by using algorithm a.” The notation “Va (K, S)” means “data to be verified, which has been generated by decrypting signature data S with key K, using algorithm a.” The notation “H (M)” means a “digest of data M, obtained by using one-way hash function H.” Any word of symmetric-key cryptographic scheme and the corresponding word of secret-key cryptographic scheme may replace each other.

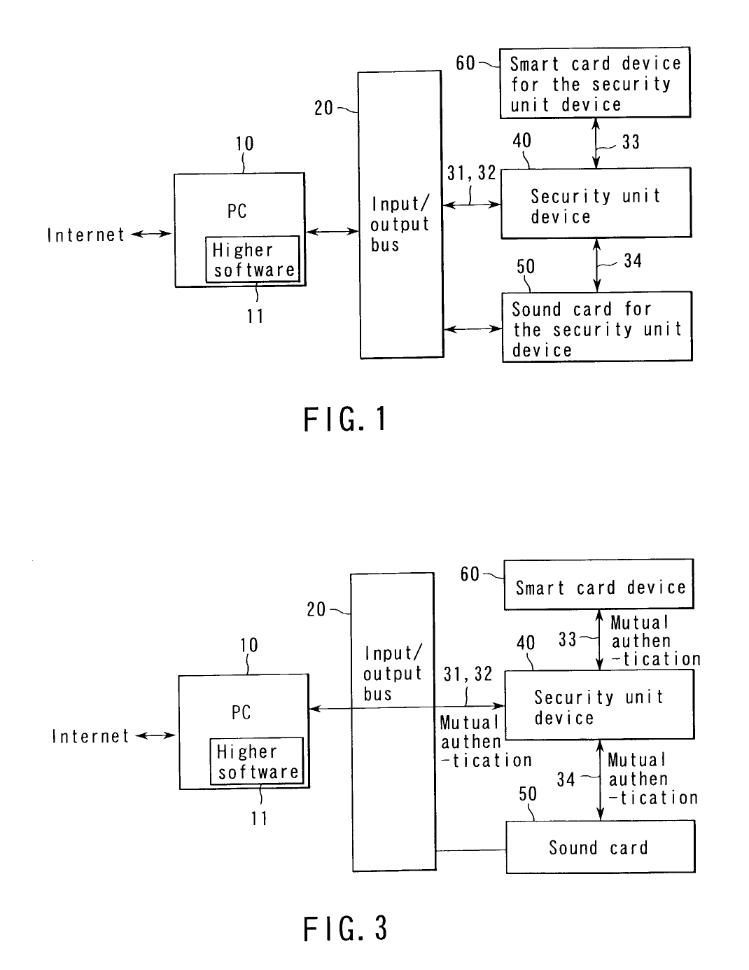

FIG. 1 is a schematic representation of a communication terminal that incorporates an encryption/decryption apparatus according to one embodiment of the present invention. The communication terminal comprises a PC 10, an input/output bus 20, a security unit device (encryption/decryption apparatus) 40, a sound card 50, and a smart card device 60. The input/output bus 20 connects the PC 10 to the bus-input interface 31 and bus-output interface 32 of the security device 40. The input/output bus 20 connects the PC 10 to the sound card 50, too. Hereinafter, a term “interface” shall be referred to as “I/F”.

The security unit device 40 is connected to the smart card device 60 by a dedicated input I/F 33, and to the sound card 50 by a dedicated output I/F 34.

The PC 10 can perform communication on a network such as the Internet. It has not only the known functions of personal computers, but also the functions specific to the present invention. Among the functions specific to the invention are: the function of registering keys K in the security unit device 40; the function of generating key data H (K) for key K; the function of transmitting and receiving encrypted data to and from the security unit device 40.

The input/output bus 20 is of a type known in the art. It may be, for example, a PCI (Peripheral Component Interconnect) bus.

The bus-input I/F 31 is provided in the security unit device 40. The I/F 31 is an interface designed to input the data on the input/output bus 20 to the security unit device 40.

The bus-output I/F 32 is provided in the security unit device 40. The I/F 32 is an interface provided to output data from the security unit device 40 to the input/output bus 20.

The dedicated input I/F 33 is provided in connected to the security unit device 40. This interface 33 is dedicated to the data communication between the security unit device 40 and the smart card device 60.

The dedicated output I/F 34 is provided in the security unit device 40. This is an interface, exclusively to output data from the security unit device 40 to the sound card 50.

The security unit device 40 is configured to encrypt and decrypt the input data and generate and verity signatures, mainly by using hardware. The device 40 is provided in the form of a PC card and can be inserted into and removed from the PC 10 that is either a desktop personal computer or a notebook personal compute. Nonetheless, the device 40 may be provided in the form of a chip set that is mounted on the main board of the PC 10. No matter whether the device 40 is a PC card or a chip set, it is desired that the device 40 should accord with the security standards applied to the communication terminal.

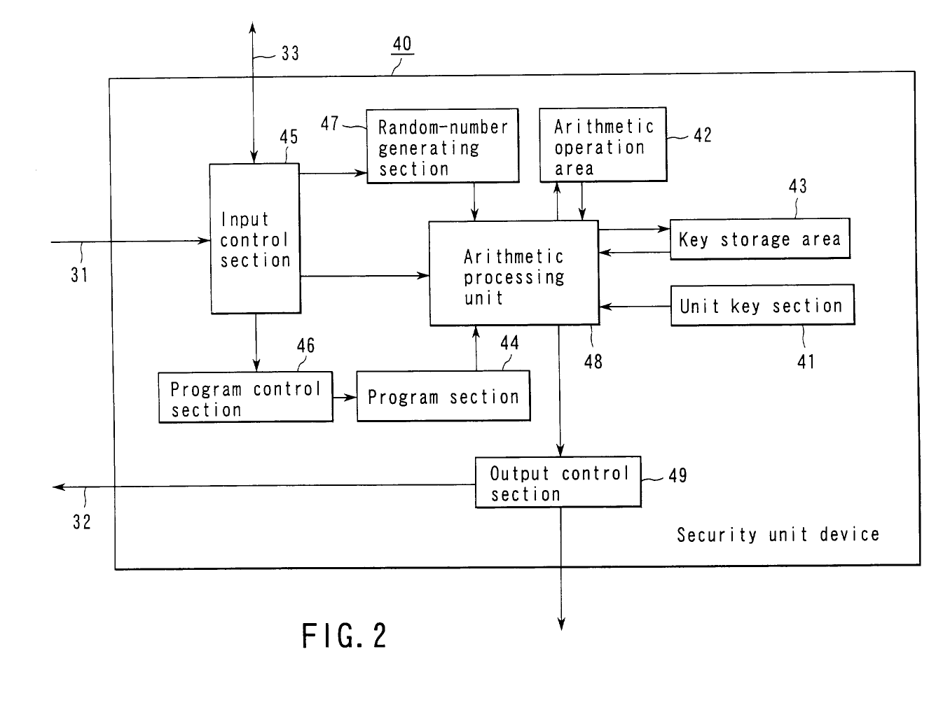

As FIG. 2 shows, the security unit device 40 comprises, besides the I/Fs 31 to 34, a unit key section 41, an arithmetic operation area 42, a key storage area 43, a program section 44, an input control section 45, a program control section 46, a random-number generating section 47, an arithmetic processing unit (MPU) 48, and an output control section 49.

The unit key section 41 is a memory that stores a unit key U that is specific to the security unit device 40 and an encryption algorithm c that uses the key U. Both the unit key U and the algorithm c can be read from the unit key section 41 into the arithmetic processing unit 48. The unit key U may be a key-pair of public-key that consists of a public key and a secret key authenticated by, for example, the certificate authority. In the unit key section 41, the unit key U may be stored in the form of data encrypted with the password for use of the device 40, which functions as an encryption key. The unit key U is never output from the security unit device 40.

The arithmetic operation area 42 is a storage area where key data items U and K and developed encryption algorithms c and a are temporarily stored. The arithmetic processing unit 48 can write and read the key data items U and K into and from the arithmetic operation area 42. The unit 48 can use the key data items U and K to encrypt data and verify signatures.

The key storage area 43 stores an encrypted key Kc (U, K) and key data H (K) which have been written from the arithmetic processing unit 48. The encrypted key Kc (U, K) and the key data H (K) can be read back into the arithmetic processing unit 48. The encrypted key Kc (U, K) has been generated by encrypting the encryption key K with the unit key U stored in the unit key section 41. Additional data may be stored into the key storage area 43. The data in the key storage area 43 may be updated. Any data item may be deleted from the key storage area 43.

The program section 44 stores a plurality of encryption algorithms (programs). These algorithms can be written into the section 44 from the program control section 46 and can be read into the arithmetic processing unit 48. Additional algorithms can be stored into the section 44. The algorithms held in the section 44 can be updated. Any algorithm may be deleted from the section 44. It is desired that the program section 44 should store at least two encryption algorithms, one of which is an algorithm of the public-key cryptographic scheme (e.g., RSA cryptographic scheme) and the other of which is an algorithm of the symmetric-key cryptographic scheme (e.g., triple DES (Data Encryption Standard) scheme).

The input control section 45 performs three functions. The first function is to transmit a random-number generating command to the random-number generating section 47 so that the security unit device 40 may authenticate the PC 10 and the smart card device 60 and may be authenticated by the PC 10 and device 60. The second function is to supply the arithmetic processing unit 48 with the data about the data encryption and the signature verification, received from the bus-input I/F 31. The third function is to supply the program control section 46 with data concerning the adding, updating and deleting of the encryption algorithms received from the bus-input I/F 31.

The program control section 46 performs two functions. The first function is to add, update and delete encryption algorithms in the program section 44, in accordance with the data that section 46 receives from the input control section 45. The second function is to verify the signature added to any encryption algorithm before adding or updating the encryption algorithm.

The random-number generating section 47 has a storage area. The section 47 is designed to generate a random number upon receipt of a random-number generating command from the input control section 45, and to store the random number in its storage area. The arithmetic processing unit 48 can read the random number from the storage area of the random-number generating section 47.

The arithmetic processing unit 48 can read data from the unit key section 41, arithmetic operation area 42, key storage area 43, program section 44 and random-number generating section 47. The unit 48 can also write data into the arithmetic operation area 42 and the key storage area 43. Further, the unit 48 performs two functions. The first function is to encrypt and decrypt the data received from the input control section 45 and verify the signature, using the areas 42 and 43 and the sections 41 and 44. The second function is to send the encrypted data, decrypted data and verified signature and the destination data to the output control section 49.

The arithmetic processing unit 48 is a combination of hardware and software in the present embodiment. Nevertheless, the unit 48 may comprise only hardware, i.e., circuits. For example, the unit 48 may comprise first and second arithmetic circuits. Each arithmetic circuit receives the data input from the input control section 45, encrypts or decrypts the data in the public-key cryptographic scheme or symmetric-key cryptographic scheme, in accordance with the key stored in the unit key section 41 or the key storage area 43. For instance, the first arithmetic circuit effects arithmetic operations of the public-key cryptographic scheme, and the second arithmetic circuit carries out arithmetic operations of the symmetric-key cryptographic scheme.

The output control section 49 receives the destination data and the processed data from the arithmetic processing unit 48. In accordance with the destination data, the section 49 supplies the processed data (i.e., the result of arithmetic operation in the unit 48) to the bus-output I/F 32 or the dedicated output I/F 34.

The sound card 50 has the function of receiving the content data from the input/output bus 20 or the dedicated output I/F 34 and supplying the content data to a playback apparatus (not shown).

The smart card device 60 is a card reader/writer. It can write and read data into and from the security unit device 40 through the dedicated input I/F 33. A smart car may be inserted into the smart card device 60. While held in the device 60, it can be verified by the security unit device 40 and can verify the security unit device 40. The smart card may store personal information about its holder. In this case, the security unit device 40 can read the personal information from the smart card.

How the communication terminal described above operates will be described, with reference to FIGS. 3 to 10.

(Mutual Authentication)

The input control section 45 forwards a random-number generating command to the random-number generating section 47 in order to initiate mutual authentication of a smart card or a PC 10 and the security unit device 40 before the data M input from the bus-input I/F 31 or the dedicated input I/F 33.

In response to the random-number generating command, the random-number generating section 47 generates a random number and holds the random number generated. The random number is read to the arithmetic processing unit 48.

As FIG. 3 illustrates, the arithmetic processing unit 48 determines whether the PC 10 or the smart card can perform a prescribed arithmetic operation with respect to the random number. The prescribed arithmetic operation is one that is carried out by using the secret key assigned to the PC 10 or the smart card. At the same time, the PC 10 or the smart card determines whether the arithmetic processing unit 48 can perform similar arithmetic operations. If the unit 48 and the PC 10 or smart card verify each other, the arithmetic processing unit 48 can encrypt the input data M.

(Encryption)

As in electronic commerce, the user of the communication terminal may want to encrypt data containing personal information, the order information and the like, to add the signature to the data, and to transmit the encrypted data together with the signature. Before encrypting the data, add the signature to the data and transmit the data and the signature, the user needs to have an encryption key registered for the data he or she wishes to transmit, so that the data may be encrypted. How the key is registered and how the data is encrypted will be explained.

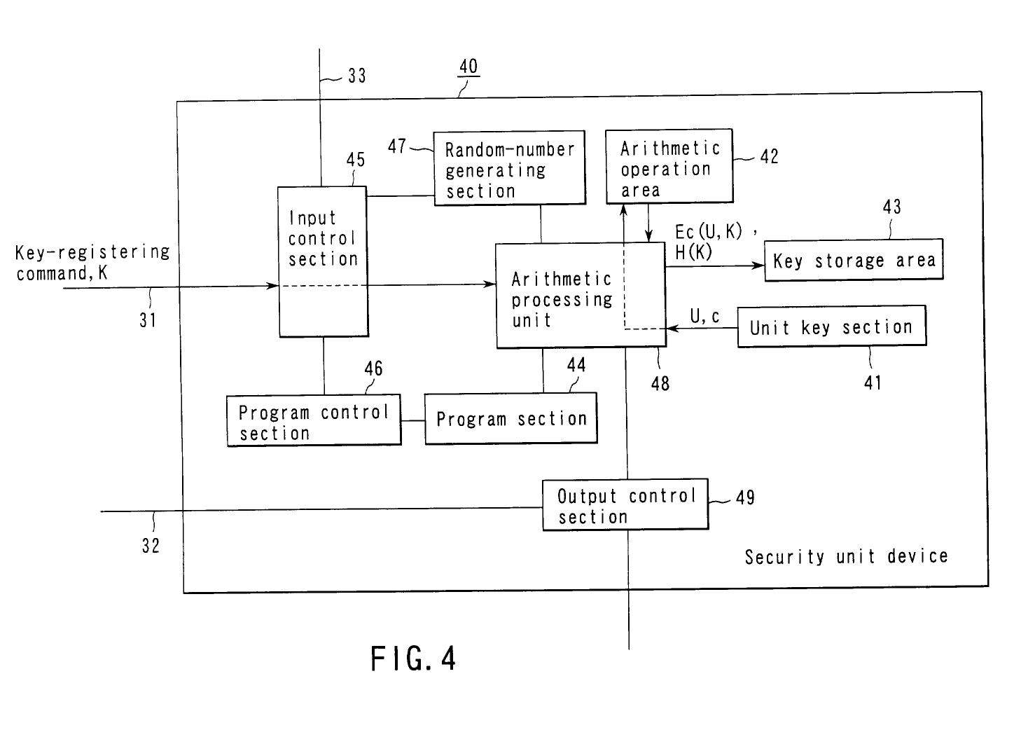

In order to register the encryption key, the PC 10 inputs a key-registering command and a encryption key K to the input control section 45 through the input/output but 20 and the bus-input I/F 31, as is illustrated in FIG. 4. The encryption key K may be a session key or the public key of the destination.

The input control section 45 supplies the key-registering command and the encryption key K to the arithmetic processing unit 48. The unit 48 interprets the key-registering command and the encryption key K and receives the unit key U assigned to the unit device 40 and the encryption algorithm c from the unit key section 41. The unit 48 then writes the unit key U and encryption algorithm c into the arithmetic operation area 42.

Next, the arithmetic processing unit 48 encrypts the encryption key K by using the unit key U and the encryption algorithm c, both stored in the arithmetic operation area 42, thereby generating an encrypted key Ec (U, K) and key data H (K). The key Ec (U, K) and the key data H (K), thus generated, are registered in the key storage area 43. The encryption key K, which has been encrypted, is thereby registered.

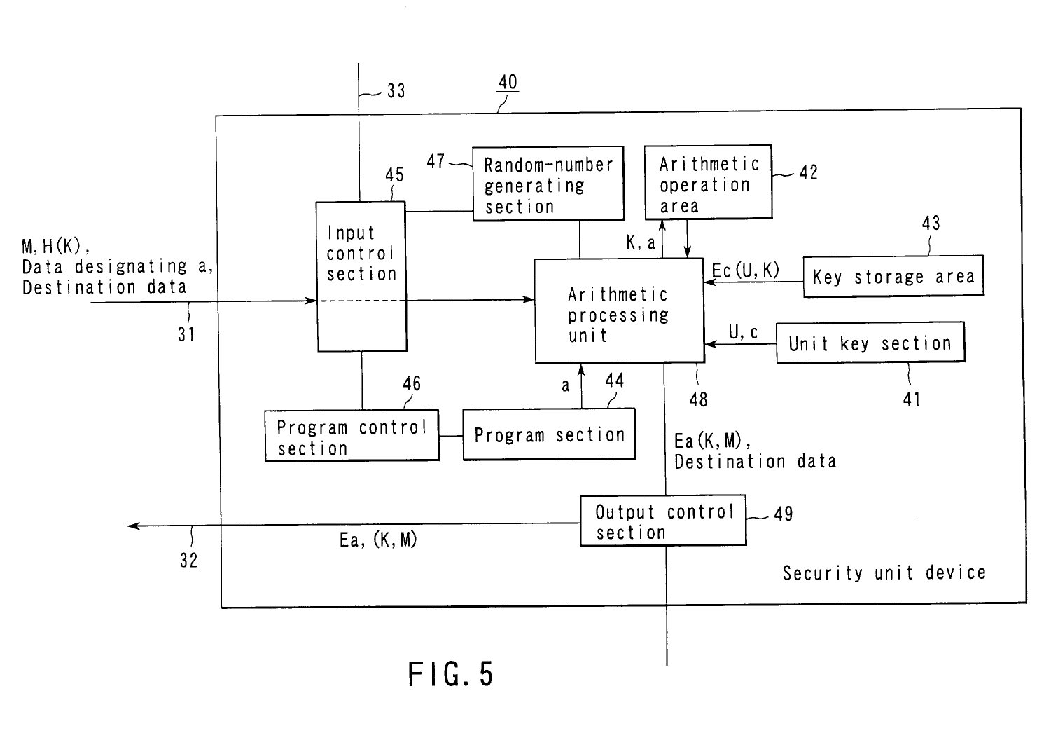

It will be described how to encrypt the data (input data M) to be transmitted, which contains the personal information, the order information and the like). As FIG. 5 depicts, the PC 10 inputs the input data M, key data H (K), the data designating encryption algorithm a, and the destination data to the input control section 45 through the input/output bus 20 and the bus-input I/F 31. The personal information contained in the input data M may be input to the security unit device 40 from the smart card via the smart card device 60 and the dedicated input I/F 33.

The input control section 45 sends the input data M, the key data H (K), the data designating encryption algorithm a, and the destination data, to the arithmetic processing unit 48.

The arithmetic processing unit 48 decrypts the encrypted key Ec (U, K) held in the key storage area 43, in accordance with the key data H (K). The unit 48 writes the encryption key K thus decrypted (=Dc (U, Ec (U, K)) into the arithmetic operation area 42. Further, the unit 48 writes the encryption algorithm a read from the program section 44, in accordance with the data designating the encryption algorithm a.

Next, the arithmetic processing unit 48 encrypts the input data M by using the encryption key K and the encryption algorithm a, both held in the arithmetic operation area 42, thereby generating encrypted data Ea (K, M). The data Ea (K, M) is forwarded to the output control section 49, along with the destination data.

In accordance with the destination data, the output control section 49 outputs the encrypted data Ea (K, M) to the input/output bus 20 via the bus-output I/F 32.

The PC 10 transmits the encrypted data Ea (K, M) to the destination designated by the destination data and linked to the Internet. The data Ea (K, M) can be used to accomplish an electronic commerce.

(Adding of the Signature)

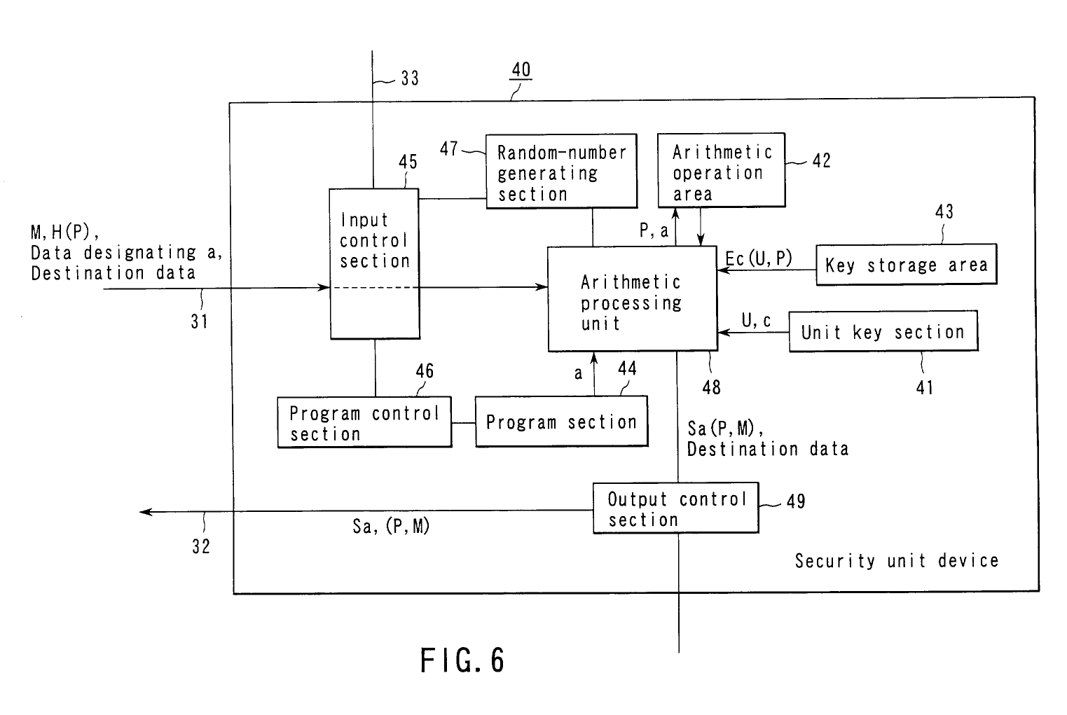

To add a signature to the input data M, the PC 10 inputs the input data M, the data H (P) about signature key P, the data designating the encryption algorithm a, and the destination data to the input control section 45 from the bus-input I/F 31 via the input/output bus 20, as is illustrated in FIG. 6.

The input/output control section 45 sends the input data M, data H (P), designating data and destination data to the arithmetic processing unit 48. In accordance with the key data H (P), the arithmetic processing unit 48 writes the signature key P stored in the storage area 43, into the arithmetic operation area 42. In accordance with the data designating the algorithm a, the unit 48 writes the encryption algorithm a read from the program section 44, into the arithmetic operation area 42.

Next, the arithmetic processing unit 48 adds a signature to the input data M in accordance with the signature key P and the encryption algorithm a, both stored in the arithmetic operation area 42. The data Sa (P, M) representing the signature is sent, together with the designation data, to the output control section 49.

The output control section 49 outputs the signature data Sa (P, M) to the input/output bus 20 via the bus-output I/F 32.

The encrypted data Ea (K, M) and the signature data Sa (P, M), thus output, may be illegally altered either by replacing the higher software 11 stored in the PC 10 and described to achieve electronic commerce with an illegal software or by implementing an illegal software between the higher software 11 and the security unit device 40.

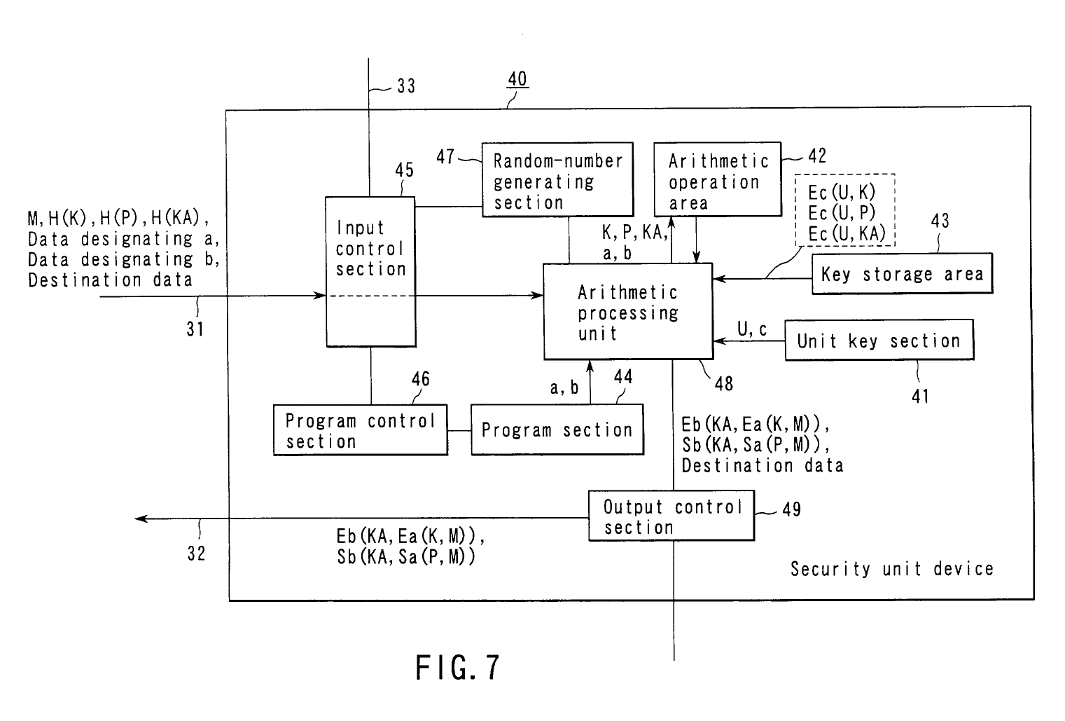

Assume that the higher software 11 installed in the PC 10 to transmit personal information has a software key KA specific to encryption algorithm b. Then, it is desirable to register the software key KA in the key storage area 43 of the security unit device 40. In this case, the arithmetic processing unit 48 encrypts the data Ea (K, M) and the signature data Sa (P, M) by using the software key KA as shown in FIG. 7. Encrypted data Eb (KA, Ea (K, M)) and encrypted key data Eb (KA, Sa (P, M)) are thereby generated. The encrypted data Eb (KA, Ea (K, M)) and the encrypted signature data Eb (KA, Sa (P, M)) are forwarded to the output control section 49, together with destination data.

The output control section 49 outputs the encrypted data Eb (KA, Ea (K, M)) and the encrypted signature data Eb (KA, Sa (P, M)) to the input/output bus 20 via the bus-output I/F 32, in the same way as explained above.

The encrypted data Eb (KA, Ea (K, M)) and the encrypted signature data Eb (KA, Sa (P, M)) output from the section 49 will not be decrypted by any other software than the higher software 11 that has the software key KA. Hence, the higher software 11, too, can be transmitted in security. Since the higher software 11 stored in the PC 10 shares the same software key KA with the security unit device 40, a security environment can be provided.

(Decryption of Encrypted Data and Signature Data)

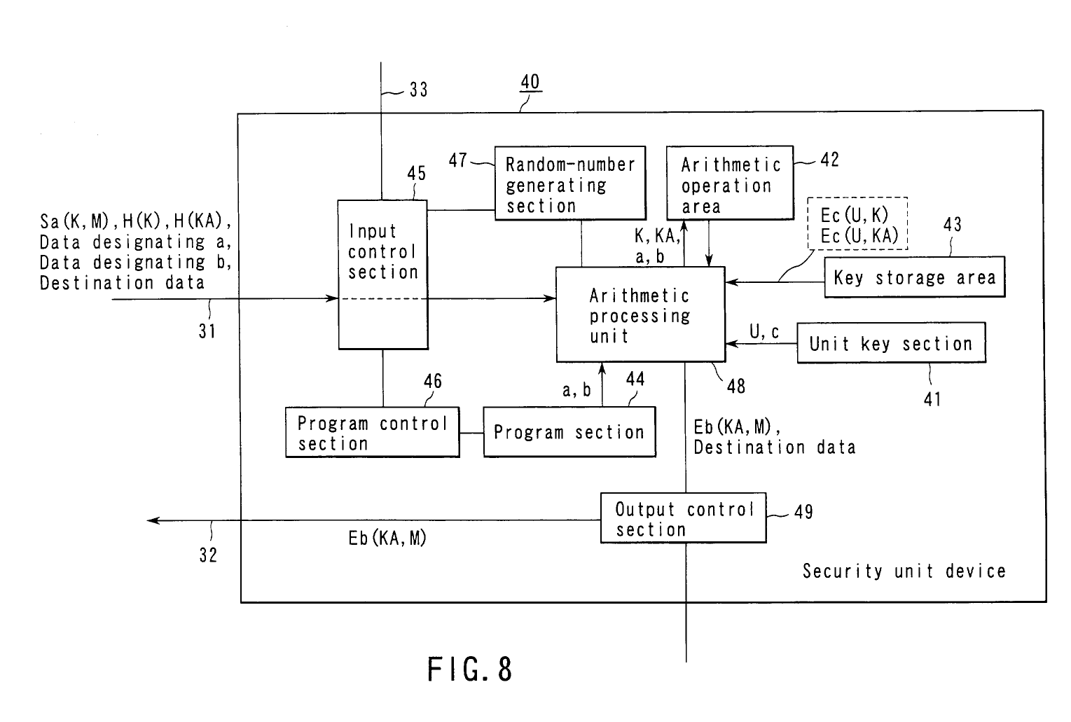

To decrypt the encrypted data, it suffices to register a decryption key K in the same way as the encryption key is registered. The decryption key K registered is used, decrypting the encrypted data. The signature data Sa (K, M) is decrypted as shown in FIG. 8, in the same sequence as the signature data is encrypted, thereby generating verified data Va (K, S) (=M)

However, the decrypted data and the verified data Va (K, M) output from the output control section 49 are nothing more than plain data items M and may be illegally altered. To prevent such illegal alteration, the plain data items M are encrypted by using the software key KA specific to the higher software 11, generating encrypted data Eb (KA, M). The data Eb (KA, M) is output to the input/output bus 20 via the bus-output I/F 32. The data Eb (KA, M) is then decrypted by the higher software 11, using the software key KA.

(Decryption of the Encrypted Contents)

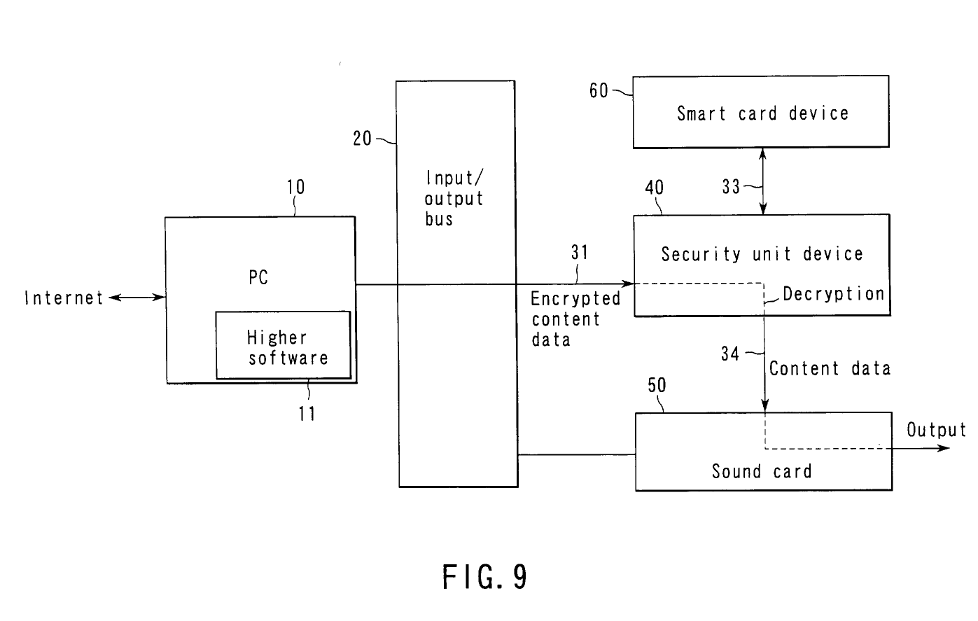

It will be described how the encrypted content data distributed is decrypted in security in the same way as music content data is played and enjoyed. As FIG. 9 shows, the security unit device 40 registers a key for decrypting the content data and verifies the signature to the content data, in the same sequence as in the encryption process. The device 40 then decrypts the content data, generating content data. The signature need not be verified in the process of decrypting the content data. The content data thus decrypted to the sound card 50 via the dedicated output I/F 34, in accordance with the destination data. The content data decrypted is not sent through the input/output bus 20 and is not influenced by the higher software 11. Therefore, the content data can be played and reviewed, free of illegal copying and illegal alteration.

The sound card 50 receives the content data from the dedicated output I/F 34 and outputs it to the playback apparatus (not shown). (Adding, Updating and Deletion of Encryption Algorithm)

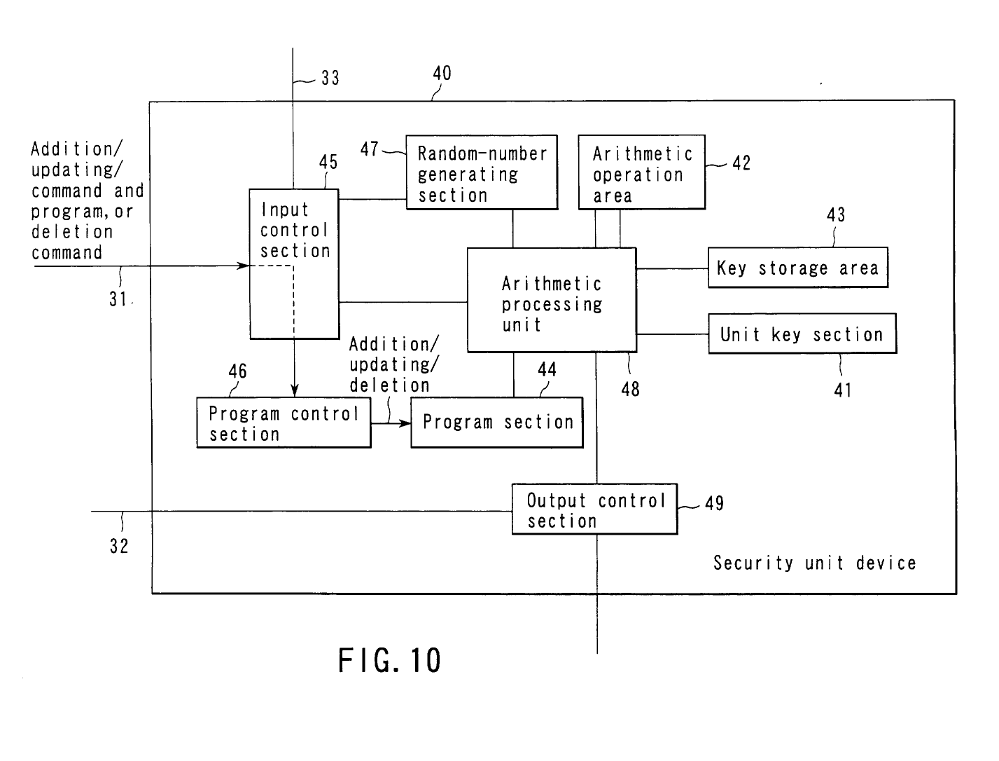

As FIG. 10 depicts, a command for adding an encryption algorithm or a command for updating the encryption algorithm and an encryption algorithm program are input to the input control section 45. Alternatively, a command for deleting the encryption algorithm is input to the input control section 45.

The input control section 45 supplies the commands it has received, to the program control section 46. The program control section 46 adds an encryption algorithm to the algorithm stored in the program section 44 in response to the algorithm-adding command, updates the algorithm stored in the section 44 in accordance with the algorithm-updating command, or deletes the algorithm stored in the section 44 in accordance with the algorithm-deleting command. Before adding an encryption algorithm or updating the encryption algorithm, the section 46 verifies the signature added to the encryption algorithm for the authenticity thereof.

As described above, the security unit 40, which operates independently of the PC 10, encrypts data, decrypts data, add a signature to the data, and verifies the signature in the present embodiment. The key data and the encryption algorithm can be protected, not processed by any software illegally used. This enables the PC 10 to exchange information in higher security with any other PCs linked to it by the Internet.

In the security unit device 40, that encryption/decryption part of the software for electronic commerce and reviewing the content data, which should be high in quality and reliability, is actually hardware, i.e., electric circuits. Thus, the security unit device 40 can guarantee high-quality and high security on encryption/decryption process. The device 40 can therefore help to realize a method of transmitting user information in security and a method of reviewing digital contents in security.

To transmit user information in security, the security unit device 40 encrypts the user information input from the smart card or the PC 10 and then transmits the user information to the PC 10. The user information that the PC 10 transmits to the Internet is protected. The user information can therefore be used in security in, for example, electronic commerce.

To provide the digital contents for reviewing in security, the PC 10 inputs the encrypted digital contents distributed via the Internet, to the security unit device 40. The security unit device 40 decrypts the encrypted digital contents. The digital contents thus decrypted are output to the sound card 50 (analog data playback/reviewing device) via the dedicated output I/F 34. The digital contents are decrypted, not using the software installed in the PC 10 at all. Nor are they output through the input/output bus 20 of the PC 10. Therefore, the encrypted digital contents distributed to the PC 10 can be played and reviewed in security even if illegal software has been added, in bad faith, to the basic software installed in the PC 10.

The smart card that holds personal information in encrypted form can be coupled in security to the security unit device 40. This protects the personal information against eavesdropping that may be illegally carried out by the use of software.

The security unit device 40 may be bound with the BIOS (Basic Input/Output System) of the PC 10 during the manufacture of the PC 10, by using code verification technique. This prevents illegal replacing of the device 40 with another security unit device.

The present invention is not limited to the embodiment described above, in which the security unit device 40 is connected to the PC 10. For example, the security unit device 40 may be a chip that is connected by an input/output bus to a PDA (Personal Digital Assistant) or a mobile telephone. Alternatively, the device 40 may be incorporated in a PDA or a mobile telephone. Either case accomplishes the same advantage as in the embodiment described above.

Thus, the present invention can be modified in various ways, not limited to a single embodiment.

The technology described in relation to the above embodiments can be embodied as a program executable by a computer. The program can be distributed to people after being stored in recording mediums, including a magnetic disk (e.g., a floppy disk or a hard disk), an optical disk (e.g., a CD-ROM or a DVD), a magneto-optical disk (MO) or a semiconductor memory.

The recording mediums can use any recording format as long as they can store a program and are readable by a computer.

An OS (Operating System) which a computer executes on the basis of a program installed on a computer from a recording medium, MW (middleware) such as database management software, network software, etc. may be part of the processing that realizes the present embodiment.

Moreover, a recording medium used in the present invention is not limited to a medium that is independent of a computer; it may be any kind of recording medium as long as it can store or temporarily store a program downloaded from a LAN or the Internet.

Two or more recording mediums may be used. In other words, the present invention covers the case where the processing of the embodiment is executed by use of two or more recording mediums. It should be also noted that the recording mediums may be of any structure as long as they fulfill the functions required.

The computer used in the present invention executes the processing on the basis of the program stored in a storage medium. As long as this function is satisfied, the computer may be of any structure. It may be a single personal computer, a system wherein a plurality of apparatuses are connected as a network, etc.

The computer used in the present invention is not limited to a personal computer; it may be an operation executing apparatus, a microcomputer or the like that is included in an information processing apparatus. The concept “computer” used in the present invention is intended to mean any kind of apparatus or device that can achieve the functions of the present invention on the basis of a program.

The present invention is not limited to the embodiments described above. When reduced to practice, each of the embodiments described above can be modified in various manners without departing from the spirit of the invention. The embodiments described above can be combined, if so desired. In such a combination, advantages produced may be unique to that combination. It should be noted that the embodiments contain inventions of various stages, and the structural elements of the inventions can be modified to derive other inventions. If an invention is derived by omitting some structural elements from the embodiments, the omitted structural elements can be compensated for with known technology when the derived invention is reduced to practice.

Lastly, the present invention can be modified in various manners without departing from the spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An encryption/decryption apparatus to be connected to a computer by an input/output bus, to encrypt or decrypt the data input from the input/output bus and to output the data encrypted or decrypted, said apparatus comprising:
key memory means for storing a key specific to the apparatus;
key storage means for storing a key-pair of public-key cryptographic scheme and a key of secret-key cryptographic scheme which have been encrypted by using the key stored in the key-memory means;
program storage means for storing an encryption algorithm of public-key cryptographic scheme and an encryption algorithm of secret-key cryptographic scheme;
an input/output bus I/F to input and output data to and from the input/output bus;
arithmetic processing means for encrypting and decrypting the data input from the input/output bus I/F by using the keys stored in the key memory means storing and key storage means and the algorithms stored in the program storage means;
an arithmetic operation area in which the encryption algorithm and encrypted/decrypted data are temporarily stored to be used by the arithmetic processing means; and
output control means for controlling a destination of the encrypted/decrypted data which is sent from the arithmetic processing means, in accordance with the data input from the input/output bus I/F.

2. An apparatus according to claim 1, wherein the key memory means stores the key specific to the apparatus, in the form of an encrypted password.

3. An apparatus according to claim 1, wherein a key encrypted by the arithmetic processing means is added, updated or deleted in the key storage means.

4. An apparatus according to claim 1, further comprising:
means for verifying the encryption algorithm input from the input/output bus I/F and storing the encryption algorithm into the program storage means when the result of verification indicates authenticity; and
means for adding a program in the program storage means and updating or deleting each program stored in the program storage means.

5. An apparatus according to claim 1, further comprising:
an dedicated input I/F to input data to the arithmetic processing means from a system different from the input/output bus I/F; and
a dedicated output I/F to output the encrypted/decrypted data from the output control means to the system different from the input/output bus I/F,
wherein the output control means controls the destination and outputs the encrypted/decrypted data to the input/output bus I/F or the dedicated output I/F.

6. An apparatus according to claim 2, wherein a key encrypted by the arithmetic processing means is added, updated or deleted in the key storage means.

7. An apparatus according to claim 2, further comprising:
means for verifying the encryption algorithm input from the input/output bus I/F and storing the encryption algorithm into the program storage means when the result of verification indicates authenticity; and
means for adding a program in the program storage means and updating or deleting each program stored in the program storage means.

8. An apparatus according to claim 2, further comprising:
an dedicated input I/F to input data to the arithmetic processing means from a system different from the input/output bus I/F; and
a dedicated output I/F to output the encrypted/decrypted data from the output control means to the system different from the input/output bus I/F,
wherein the output control means controls the destination and outputs the encrypted/decrypted data to the input/output bus I/F or the dedicated output I/F.

9. An apparatus according to claim 3, further comprising:
means for verifying the encryption algorithm input from the input/output bus I/F and storing the encryption algorithm into the program storage means when the result of verification indicates authenticity; and
means for adding a program in the program storage means and updating or deleting each program stored in the program storage means.

10. An apparatus according to claim 3, further comprising:
an dedicated input I/F to input data to the arithmetic processing means from a system different from the input/output bus I/F; and
a dedicated output I/F to output the encrypted/decrypted data from the output control means to the system different from the input/output bus I/F,
wherein the output control means controls the destination and outputs the encrypted/decrypted data to the input/output bus I/F or the dedicated output I/F.

11. An apparatus according to claim 4, further comprising:
an dedicated input I/F to input data to the arithmetic processing means from a system different from the input/output bus I/F; and
a dedicated output I/F to output the encrypted/decrypted data from the output control means to the system different from the input/output bus I/F,
wherein the output control means controls the destination and outputs the encrypted/decrypted data to the input/output bus I/F or the dedicated output I/F.

12. An encryption/decryption apparatus to be connected to a computer by an input/output bus, to encrypt or decrypt the data input from the input/output bus and to output the data encrypted or decrypted, said apparatus comprising:
key memory means for storing a key specific to the apparatus;
key storage means for storing a key-pair of public-key cryptographic scheme and a key of secret-key cryptographic scheme which have been encrypted by using the key stored in the key-memory means;
an input/output bus I/F to input and output data to and from the input/output bus;
a first arithmetic operation circuit which performs encryption/decryption of the public-key cryptographic scheme on the data input from the input/output bus I/F by using the keys stored in the key storage means and the algorithms stored in the program storage means;
a second arithmetic operation circuit which performs encryption/decryption of the secret-key cryptographic scheme on the data input from the input/output bus I/F by using the keys stored in the key storage means and the algorithms stored in the program storage means;
an arithmetic operation area in which the data encrypted by the first arithmetic operation circuit or the second arithmetic operation circuit is temporarily stored; and
output control means for controlling a destination which is to receive the data encrypted or decrypted by the first arithmetic operation circuit or the second arithmetic operation circuit, in accordance with the data input from the input/output bus I/F.

13. An encryption/decryption method for a computer capable performing network communication, said method comprising:
connecting an encryption/decryption apparatus to the computer by an input/output bus; and
encrypting data to be transmitted and decrypting data received in the encryption/decryption apparatus to enable the computer to perform the network communication.

14. An encryption/decryption method for use in an encryption/decryption apparatus connected to a computer by an input/output bus and configured to encrypt and decrypt data input from the input/output bus I/F and to output the data encrypted or decrypted, said method comprising:
storing a specific key that is specific to the apparatus;
storing an encryption program of public-key cryptographic scheme and an encryption program of secret-key cryptographic scheme;
encrypting a public key of the public-key cryptographic scheme and a secret key of the secret-key cryptographic scheme individually, input from the input/output bus I/F, by using the specific key and the program of the cryptographic scheme associated with the specific key, and storing the keys thus encrypted;
acquiring the secret key or the public key by decrypting one of the encrypted keys stored and associated with the secret key or the public key by using the specific key in accordance with key data input from the input/output bus I/F;
reading one of the programs stored, which is designated by designating data input from the input/output bus I/F:
encrypting or decrypting the data input from the input/output bus I/F′ by using the public key or secret key decrypted and the program read; and
outputting the data encrypted or decrypted, in accordance with destination data input from the input/output bus I/F.

15. A method according to claim 14, further comprising:
connecting a smart card to the encryption/decryption apparatus by a dedicated input I/F that is different from the input/output bus I/F;
performing mutual authentication between the smart card and the encryption/decryption apparatus; and
encrypting or decrypting the data input from the input/output bus I/F when the verification proves that the smart card and the encryption/decryption apparatus are authenticated.

16. A method according to claim 14, further comprising:
storing a key specific to a higher software installed in the computer; and
outputting the data encrypted or decrypted, in the form of data encrypted by using the key specific to the higher software.

17. A method according to claim 14, further comprising:
verifying an encryption algorithm input from the input/output bus I/F, and storing the algorithm when the result of verification indicates authenticity; and
adding a program, updating each program stored, or deleting each program stored, in accordance with an edition command input from the input/output bus I/F.
